(19) United States
(12) Patent Application Publication
(10) Pub. No.: US 2016/0330237 A1
(43) Pub. Date: Nov. 10, 2016

(54) System and Method for Blocking Internet Data Brokers and Networks

(71) Applicant: RedMorph, LLC, Cranberry Twp., PA (US)

(72) Inventor: Abhay Edlabadkar, Wexford, PA (US)

(21) Appl. No.: 15/150,183

(22) Filed: May 9, 2016

Related U.S. Application Data
(60) Provisional application No. 62/158,995, filed on May 8, 2015.

(51) Int. Cl. H04L 29/06; G06F 17/30; G06F 3/0484; H04L 29/08

(52) U.S. Cl. CPC H04L 63/1475; H04L 67/02; H04L 67/22; G06F 17/30867; G06F 3/04842; H04L 63/0245; H04L 63/0272; H04L 63/0281

(57) ABSTRACT

The Data Traffic Controller is a system and method that provides users with the ability to view, control and protect themselves during their online browsing. Most websites come with an array of tracking elements and third-party content which could be unknown or misleading to the user. The Data Traffic Controller interface embraces member functions, events, and properties. The member functions provide high level services such as Proxy, VPN, filter inappropriate content, block or allow certain websites, detect and block trackers, and control browser behavior which includes cookies and history retention. The Data Traffic Controller displays notifications and statistics as it encounters events. It also represents all the tracking and third-party activity and their connectedness using a graph, where the user has the ability to further control individual elements.

### CROSS-REFERENCE TO RELATED APPLICATION

This application claims priority to U.S. Provisional Patent Application No. 62/158,995 filed on May 8, 2015, entitled “System and Method for Blocking Internet Data Brokers and Networks” the disclosure of which is hereby incorporated in its entirety by reference.

### BACKGROUND OF THE INVENTION

1. Field of the Invention

The invention relates to a system and method for safely browsing websites or using applications (app(s)) on any device while connected to the Internet. More specifically, the invention relates to a system and method that integrates various algorithms and elements to give complete Control, Protection, and Privacy back to the user.

2. Description of Related Art

The Internet is a global computer network providing a variety of information and communication facilities consisting of interconnected networks using standardized communication protocols. Every day the amount of information and number of users accessing the Internet grows. With this intense focus on the Internet and Internet-related standards, there is an increasing demand for applications that can access the Internet and take advantage of Internet related standards. This demand for Internet-enabled applications is making the Internet and Internet standards a key platform for new application software development.

In this entire cycle, the companies fall into two categories and can see, track, and record the user's Internet activity, behavior, and data based on their category. Each user is assigned an identification number, or UID, which is associated with the user for recording entire records of metadata on each user by many companies. The data and metadata is used at different steps and can be utilized for various purposes depending on the step, among other things. One of ordinary skill in the art would understand the unlimited number of uses for such data and, thus, the need for protecting it.

Companies providing Internet access can record and track the user's entire Internet activity and unencrypted data as long as their network or access points are used. These companies can then sell this user data to data brokers, advertisers, websites, etc.

The user can usually be identified by their actual device id (mobile phone, laptop/desktop device) and IP address (actual home/office location), etc. Additionally, the user can be identified based on the actual data transmission (login id/password, emails, social media interactions, etc.).

Companies providing content can identify and track several user data points, such as the actual device ID and IP address, html headers for webpage request and response, user login and password, user's browsing history, and user browser bookmarks.

These companies bundle their webpage's content with tracking technology (trackers) that is downloaded on the user's device. These trackers include cookies, web analytics, web beacons, and canvas fingerprinting. They read user's data and then can snoop around the browser and other device folders and transmit this data back to the website.

These companies also sell and allow certain third-party companies to download their own trackers and content on the webpage. These companies include advertisers, who track and record all data and use the information to identify the user and target advertisements. Also, data brokers track and record the user's activity such that it can be sold to anybody. Both of these types of companies can track a user across multiple websites and catalogue the user's activity, data, and metadata. User's activity includes—audio from the device mic, video from the device camera, cursor movements, actual key stroke logging, eye tracking, browser information (other cookies present, add-ons, bookmarks, etc.), and physical device information (display adapter feedback, etc.).

Users remain ignorant of tracking and are unaware of Internet tracking and the types of tracking technologies. Even the ones that are aware, the majority of them do not understand the technology and the extent to which they are being tracked at each website and across websites by various companies.

Tracking companies, which actually track personal information, share data between all tracking companies, which internally helps them identify the user with a fairly high amount of certainty.

Most websites now not only directly track users' activity while users are on their website, they also allow many third-party partners to track the users at a very intrusive level. These companies include data brokers, advertisers, etc. Additionally, it is now common practice for these third-party sites to not only deploy their own cookies, trackers, and content, but also allow their partners to track the user. This way, it is possible for over 150 companies to track the user when they are visiting a single website. The kinds of data tracked includes video, eye tracking, cursor tracking, keyboard logging, actual clicks, and physical data on the users' browser and device.

### SUMMARY OF THE INVENTION

A system to give users the ability to prevent companies from tracking their Internet activity and personal data, prevent websites and apps from loading tracking technology (cookies, trackers, web analytics, web beacons, etc.) and third-party content, and filtering inappropriate content to their device.

The present invention is directed to a computer-implemented system and method for protecting users while browsing the Internet. The system is capable of displaying a plurality of selectable options in at least one graphical user interface. The system is capable of intercepting, on a user computer from a web browser executing on the user computer, a plurality of requests for content associated with a host webpage. The computer-implemented system creates a response to a user selection of a first selectable option of the plurality of selectable options, the response for connecting to at least one of a virtual private network, a proxy server, or an encrypted connected proxy server. Also, a computer-implemented system responds to user selection of a second selectable option of the plurality of selectable options. The response, caused by the second selectable option of the computer implemented system, analyzes each of the plurality of requests for content based on at least one database stored locally on the user computer to identify requests associated with content to be blocked. The computer-implemented system transmits a second plurality of requests for content associated with the host webpage, wherein the second plurality of requests for content comprises the plurality of requests for content without the requests for content associated with the content to be blocked. The transmission is sent to an Internet content provider through intermediaries, for example over a connection to an Internet service provider(ISP) or other connection oriented services. The computer-implemented system receives web content from the Internet service provider corresponding to the second plurality of requests for content. In response to a user selection of a third selectable option of the plurality of selectable options, it filters the received web content based on at least one keyword.

The graphical user interface or multiple graphical user interface is displayed within a web browser or application display interface. The steps of intercepting, transmitting, and receiving are performed by a web browser extension, API, or plug-in. Further steps of the invention include, after receiving the web content, generating a graphical user interface comprising a visual diagram illustrating the plurality of requests for content associated with the host webpage and the requests for content associated with the content to be blocked. In addition, it includes determining a page load speed for the host webpage and displaying the page load speed. The content to be blocked comprises at least one of the following: a tracker, a cookie, third-party content, a pop-up window, a web bug, or any combination thereof. Encrypting, by the virtual private network or proxy, outgoing data from the user computer, and decrypting, by the virtual private network or proxy, incoming data from the host website.

The invention includes a computer program product, the computer program product including program instructions for protecting users browsing the Internet. A non-transitory computer-readable medium including program instructions for providing a web browser extension or plug-in that, when executed by a user computer, causes the user computer to run a web browser to protect the computer. A display is provided for viewing a plurality of selectable options. A web browser running on the user computer sends and receives requests and responses. The browser receives an indication of a URL for a host webpage to be visited in response to determining that a first selectable option of the plurality of selectable options has been selected to intercept a plurality of requests for content associated with the host webpage from the web browser to determine a subset of requests for content to be blocked from the plurality of requests for content based, at least partially, on at least one database. The computer runs the browser to transmit a second plurality of requests for content comprising the plurality of requests for content with the subset of requests for content to be blocked to an Internet service provider or intermediary. The content can be removed by database query or, alternatively, by extraction using scripts or program control after the data has been sent to the database. The browser receives web content from the Internet service provider based on the second plurality of requests for content and then operates on the web content and in response to determining that a second selectable option of the plurality of selectable options has been selected causing the filtering of the web content based, at least partially, on at least one keyword and displaying the web content in the web browser.

The computer program product is programmed to handle a third selectable option in response to determining that a third selectable option of the plurality of selectable options has been selected by connecting to at least one of a virtual private network (VPN) and a proxy server, wherein the second plurality of requests for content are encrypted before being transmitted to the host webpage, and wherein the web content is decrypted before being received by the user computer.

The present invention is directed to a system for protecting users browsing the Internet. The system includes a computer processor device, web browser, display, transmitter, and receiver. The web browser includes a web browser extension or plug-in for executing on a user device. The device is programmed or configured to display a plurality of selectable options and receive, from a web browser executing on the user device, an indication of a URL for a host webpage to be visited and determines, in response, that a first selectable option of the plurality of selectable options has been selected and intercepts a plurality of requests from the web browser for content associated with the host webpage, determining a subset of requests for content to be blocked from the plurality of requests for content based, at least partially, on at least one database, transmitting a second plurality of requests for content, to the Internet, comprising the plurality of requests for content minus the subset of requests for content to be blocked. It receives web content from the Internet service provider based on the second plurality of requests for content and determines, in response, that a second selectable option of the plurality of selectable options has been selected. It filters the web content based, at least partially, on at least one keyword. Displaying the web content in the web browser and a server computer configured to provide a proxy or virtual private network, the server computer is configured to encrypt outgoing data from the user device and decrypts the web content before being received by the user device.

The present invention is directed to a Data Traffic Controller system configured for controlling a user's computer for securely browsing the Internet. The system having a processor, a first memory, and a second memory. The first memory, coupled to the processor and configured to store blacklist, stores at least a website that is tracking user activity. A second memory is configured for storing user preferences. A first memory stores a first selectable option to initiate and create a secure channel for a user's entry to the Internet through a proxy service. A second memory stores a second selectable option for turning on a blocker. A blocker is configured to read the contents of the blacklist to provide control of the browser for the downloading of cookies, trackers, and third-party content. A monitor of incoming and outgoing traffic, following a request made through a browser, intercepts the request by the monitor and compares against a tracker database to stop requests for malicious or intrusive content. All third-party content requests are also identified.

A secure channel blocks access to any outside party for gathering personal information. It reports a visual representation of the trackers and third-parties that the browser and user have exposure to on every website and across different websites. It has three layers of protection that the user can selectably turn on or off, as well as encryption services to prevent Internet service providers from tracking a user's Internet activity or browser and flexible control for changing from one website to a second website based on a user's preferences and desire for allowing websites to track them in return for access to the website's content. It has configured ability to filter or block websites based on specific URLs or words.

Various objects, features, aspects, and advantages of the present invention will become more apparent from the following detailed description of preferred embodiments of the invention, along with the accompanying drawings, in which like numerals represent like components.

### SHORT DESCRIPTION OF THE DRAWINGS

FIG. 1A is a system diagram showing user access to the Internet during a web browsing session or when using an application.

FIG. 1B is a system diagram of a browser of FIG. 1A.

FIG. 1C is an architectural diagram proxy network operable with user computer of FIG. 1A and a browser of FIG. 1B.

FIG. 2 is a system diagram illustrating prevention and control of the Data Traffic Controller system.

FIG. 3 is a process flow diagram for a Data Traffic Controller function and process

FIG. 4 is a process flow diagram for a Data Traffic Controller function and process

FIG. 5 is a process flow diagram for a Data Traffic Controller function and process

FIG. 6 shows a depiction of advance settings user interface of the Data Traffic Controller.

FIG. 7 shows a depiction of a control panel user interface of the Data Traffic Controller.

FIG. 8 shows a depiction of a word filter user interface of the Data Traffic Controller.

FIG. 9 shows a depiction of a content blocker user interface of the Data Traffic Controller.

### DESCRIPTION OF THE INVENTION

In accordance with the invention, a system and method are provided to provide control, protection, and privacy to an Internet user. This Data Traffic Controller system provides visibility and the ability to control some or all aspects of undesired or inappropriate content, tracking, and third-party content. The Data Traffic Controller system can be installed across all the users' devices (laptop, desktop, mobile devices, and any device that has a browser and can access the Internet). It can also be installed as a browser add-on or extension or natively as an app on any device.

Users access the Internet via devices such as laptops, computers, smart phones, smart TVs, computer pads, watches, etc. This is mainly accomplished by using a browser or directly via apps installed on their device. Those in the art will understand that a number of variations may be made in the disclosed embodiments, all without departing from the scope of the invention, which is defined solely by the appended claims.

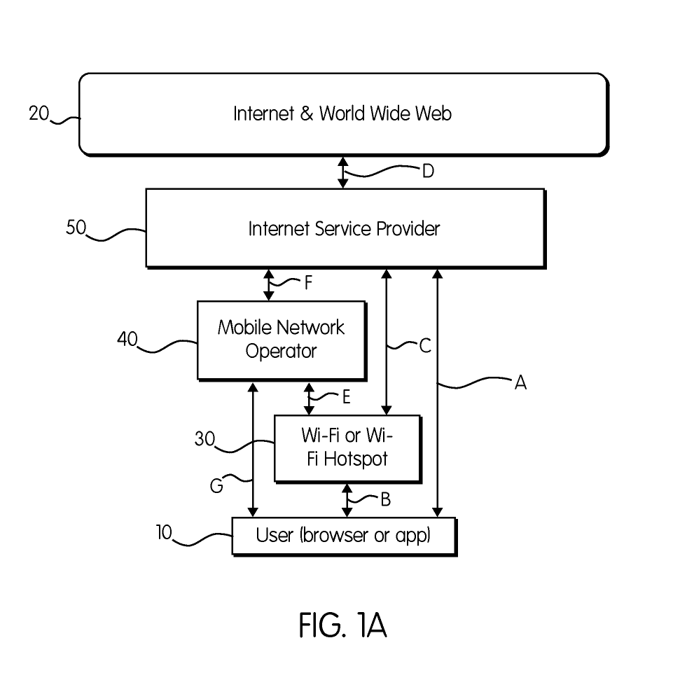

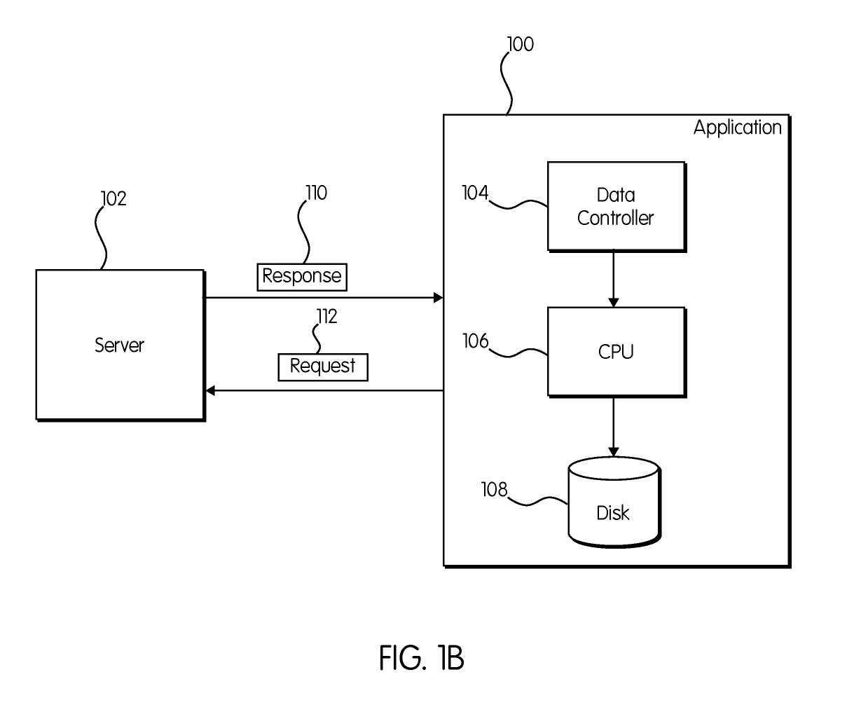

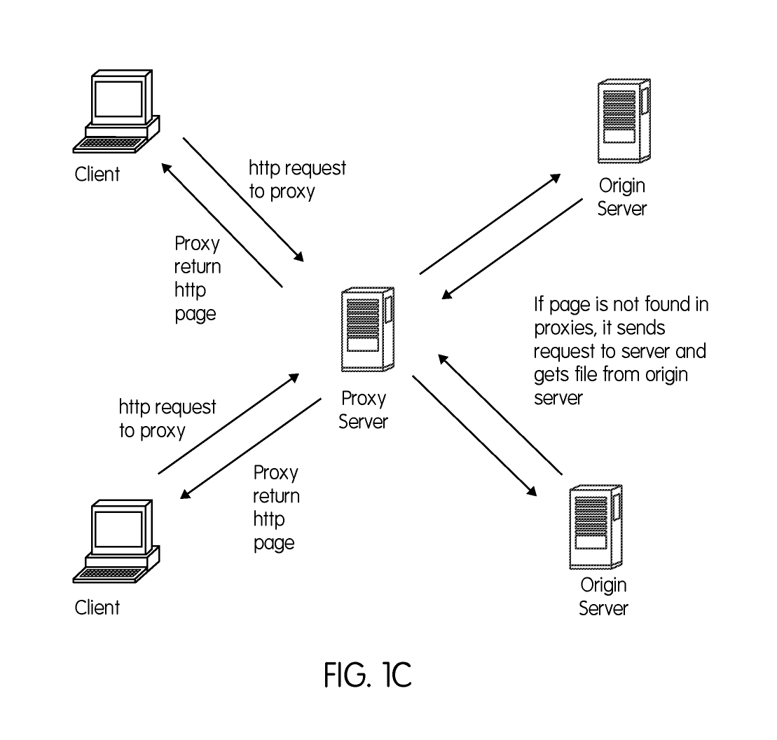

As shown in FIG. 1A, the flow of data and the parties involved when a user 10 goes online for accessing webpages and other content on the Internet 20 is accomplished by both companies providing content and companies providing Internet access. The flow of data and information between a user 10 and the Internet 20 starts when a user 10 wants to access a typical webpage or online content and when a user's browser or app 10 sends out a request A for a webpage or data to the Internet service provider (“ISP”) 50, either directly from their device or by sending a request B through a Wi-Fi connection 30, Wi-Fi Hotspot 30 or a Mobile Network Operator 40. Request B is in turn forwarded as a request C sent from the intermediate network. The sent requests could include the actual URL (webpage), data request, as well as data about the communication that could be used to identify the user's device, device type, browser type, and user location data etc. so that the content can be accurately routed and delivered back to the user 10.

With reference to FIG. 1A, the ISP 50 in turn sends the request D for content to the content provider on the Internet 20, such as a website, application database/server, or content distribution network. The content provider reviews the user's request, authenticates the request if required, and then transmits a response D to the request for the webpage or content back to the ISP 50. Then, the response A with content is transmitted back from the ISP 50 to the user 10. An Internet content provider is a website or organization that handles the distribution of online content, such as blogs, videos, music, or files. This content is generally made accessible to users and often in multiple formats, such as in both transcripts and videos.

With reference to FIG. 1B, a client application 100, such as a browser or mobile app, may send a request 112 to server 102 and server 102 may reply with response 110. The request 112 may include requests for content associated with a host webpage. The client application 100, uses a data controller 104 to handle the data. The data controller 104 processes the data. When it finds requests, it can pass the request to the computer CPU 106 for processing against a database of options selected by the user of the application as discussed below. CPU 106 analyzes requests and responses and generates its own response based on a user selection stored in a disk 108, such as stored or other types of physical memory devices. When a request is prepared to send to the Internet, the CPU 106 can block content in the page based on options stored in the disk 108. A first user option stored in disk 108, could be for creating a response for connecting to at least one of a virtual private network, a proxy server, or an encrypted connected proxy server. A second request could be for a page that is blocked based on user selectable options stored in the database. The CPU 106 creates a configured request by blocking the content associated with a blocked website or content in the data controller 104. This happens before the request is sent to the Internet. Additional requests are possible, following the same path. The requests are handled by the data controller 104, preventing traffic that is unwanted. If an option comes in that requires blocking of content, based on and caused by using information from the options stored in memory disk 108, the CPU 106 can monitor and analyze as a servant to the data controller 104. The options stored in the disk 108 are used to block traffic by erasing, extracting, or otherwise blocking the content requests from the requesting page.

The request, when created and updated for blocked data, is sent to the data controller 104 for transmitting a request for content associated with a host webpage, for content without the requests for content associated with the content to be blocked.

With continuing reference to FIG. 1B, the transmission sent to an Internet content provider, server 102, through intermediaries as shown in FIG. 1A, for example over a connection to an Internet service provider or other connection oriented services. The application 100 receiving responsel 10 content from the server 102 through the Internet service provider of FIG. 1A, corresponding to the second plurality of requests for content handled by the CPU 106. One of skill in the art can understand that various options can be selected and a variable number of configurable requests invoked, for example a user selection of a third selectable option can trigger filtering the received web content based on at least one keyword.

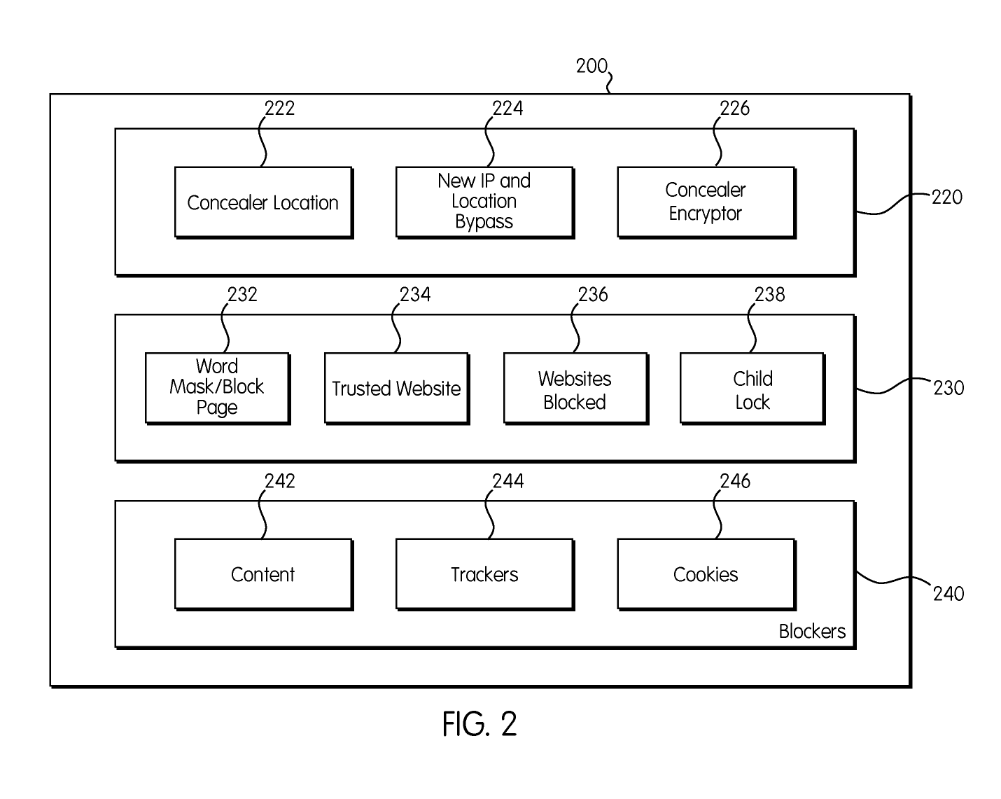

As shown in FIG. 2, three layers of protection of the Data Traffic Controller system 200 are shown, the layers providing individual protection capabilities from the flow of data and information a user can confront when to accessing a typical webpage or online content. The Data Traffic Controller system 200 detects and visually depicts the trackers and third-parties computers a user has exposure to on websites and spanning different website connections. The Data Traffic Controller system 200 also offers three layers of protection. The protections start when a user's browser or app sends out a request for a webpage or data to an address on the Internet through a third-party provider, which relay traffic on the Internet between points, hubs, gateways, switches, etc., such as an Internet service provider or broadband provider. Access can be through various known connections, such as directly from one device to another device or through a Wi-Fi connection, Wi-Fi Hotspot, or a Mobile Network Operator. These types of requests include numerous data points for which secrecy may be required. Web requests and services can include browser specific or can apply to applications over the Internet, such as Web Service, SOAP, and WCF, can be protected traffic. In addition, requests that are not over the Internet can be handled. Mobile connections to applications can be handled using Internet protocols, even if the requests and responses are not from the public Internet. Data points can include the actual URL for a particular resource, page, or data request, as well as data that is provided by the computer and can be used to identify a user, a user's device and device addresses, other devices associated to the device, device types, browser types, and user location data. A person in the art would understand that other types of content could be identifying and various combinations of device data could have a similar identifying effect. The content can be secured using the Data Traffic Controller system 200 to provide secrecy while the information is routed and delivered back to the user.

As shown in FIG. 2, the first layer 220 includes network level protections for security of packetized messages along the route to a content provider, as well as masking information. At this level, it acts as a proxy or integrated remote access browser specific private network with encryption service to prevent or control the release of information that would prevent third-party providers from having, aggregating, storing, tracking, sharing, or otherwise utilizing Internet activity and browser information for a user, computer, or group utilizing the Data Traffic Controller system 200.

The first layer 220 has a location concealer 222 for using remote servers to create a mask of location information, new IP and location bypass 224, and concealer encryptor 226 for establishing a private connection. A concealer is similar to a proxy. As showing in FIG. 1C, a proxy handles Internet communications, sending and receiving request and response packets. Location concealer 222 creates anonymous web browsing in a preferred embodiment, giving a choice of server locations to use. For example, location concealer 222 can give any number of choices of location, such as varying locations around a state, region, or country to affect the appearance of a request. Giving multiple choices of locations provides greater anonymity. A person of ordinary skill in the art would appreciate that, in addition to locations, certain other parameters of the concealer could be adapted to increase anonymity. For example, the location concealer 222 can be programmed to change the location at intervals, such as daily, hourly, or monthly, and randomly to avoid detection. It can be programmed to cycle through remote servers; if the 26 servers exist, the cycle would take 26 days to cycle if a period of one day were pre-determined. The location concealer 222 is one or more computers and, in a preferred embodiment, numerous computers acting as a server or servers for performing as a layer between a client computer and the Internet. The computers perform tasks normally handled by a client, for example handling, receiving, caching, and sending requests and responses. The concealer can handle requests based on message addresses, with the client computer programmed to route to the concealer in cases where the address is identified with the concealer. The website illustrated in FIG. 1A is not limited to the constructional detail shown there or described in the accompanying text. As those of skill in the art will understand, a suitable web architecture can be developed from numerous different server patterns and employment of redistribution and off-loading of processes in order to balance and optimize algorithms and processes. As a result, any website providing content cannot identify where the request is coming from, because the location concealer 222 has essentially disguised the location by providing an alternative starting point for a user. The Data Traffic Controller system 200 uses the location concealer 222 as a proxy to secure a connection between a user device and server to disguise information from the requested website. It has the ability to disguise location and protect information from websites.

A user can bypass 224 the location concealer 222 to open the connection to the website. The bypass 224 will ignore the location set by the concealer and use an actual location instead. Memory is provided on the Data Traffic Controller system 200 for storing, either remote or in the cloud, for retention of a bypass list. The bypassed website will ignore the location set by the proxy, using your actual location instead. You can add a website to the proxy bypass list by domain, website, content, or username. For example, “Netflix”, can be bypassed since a user needs to log on to see a movie, it makes no sense to prevent Netflix from identifying you by using the Proxy. The bypass list can be used to ecommerce sites frequented and not disguised.

The concealer encryptor 226 can combine with the location concealer 222 to establish complete security by encrypting a user's traffic to provide a similar level of protection as a virtual private network (VPN). Similar to the case of the VPN, in addition to web traffic, the entirety of device browser is encrypted before transmission. Applications, email, local programs, and message oriented software are all encrypted before entering the outbound connection stream. Native encrypted clients can use any type of encryption protocol. The encryptor can work with protocols standardized on the Internet or can be customized to work with non-Internet protocols or proprietary encryption algorithms, including a non-limiting list of cipher suites including RSA, ECDH, DES, RC4, or AES-256 encryption to provide anonymity for all of a device's traffic, not just web browsing activity. AES-256 encryption can be used across a connection to make sure that monitoring is blocked. The encrypted concealer provides security control of a client and host IP address and port address. This protects your online identity and data, creates privacy at Wi-Fi hotspots, acts as a virtual firewall, and bypasses Internet censorship restrictions. In addition to providing similar service as a web proxy, the encryptor 226 provides a more secure connection and completely encrypts all browser.

The Data Traffic Controller's concealer encryptor 226 secures from tracking requests based on IP address or other request message information. The Encryptor 226 is also used to stop an ISP from reading packet data sent over the Internet by encrypting. Encryptor 226 is for encrypting traffic between a client and remote server acting as a proxy, up to a point where traffic is passed to the Internet, or connection with the broader Internet, keeping the target website from discovering identity information. Encryptor 226 can, for example, use strong encryption to prevent an ISP from using snoop or listening techniques to monitor traffic. Also, encryption stops third-party entities from monitoring a connection for specified information. Encryptor 226 makes any Internet traffic invisible to listeners on the network and stops interception on local area or wide area networks, including Wi-Fi hotspots, Internet service providers, Mobile Service Providers, or any other network. Encrypted proxy integration is accomplished within the Data Traffic Controller system 200.

The encryptor 226 and location concealer 222 are browser functions. When the user is logged in to an account with appropriate access, the InData Traffic secure connection can establish the user to securely access the Internet from any browser on any computer anywhere in the world. Once it is downloaded onto a device, other web protocols are addressed, such as cookies, third-party content, analytics, trackers and web bugs that can immediately identify and start tracking. In combination with a Proxy or VPN connection, your identity is completely exposed. For the best protection and privacy, using Proxy or VPN connection along with a cookie and tracker blocking technology is recommended. The combination is not limited to any certain combination however, and the features are not limited to the specific cipher suites.

At the second layer 230, word mask and block page 232 provides a button to filter or block websites based on specific URLs or words. If the user chooses to have website or word filter on, then the webpage content is scanned for any inappropriate words or websites contained in the lists. Based on user preferences, the words are either masked or the entire website is blocked.

Depending on user's filter preference, the data gets masked or blocked for inappropriate words. While accessing a certain website, the program can word mask and block page 232 for a website using word filter. Then when the particular incoming web pages are being scanned, the word filter triggers the Data Traffic Controller system 200 to block the website. Data Traffic Controller system 200 provides the capability to modify the word filter by entering a word to add to a blocked word list. A person of ordinary skill would understand that other features could be included. For example, a browser could be pre-loaded with profiles for age group, sex, or other demographic profiles. The profiles could include default word and website lists block list, acting as a baseline for the specific demographic. The profile could be preloaded to mask inappropriate words, block specific sites, block any site containing certain words, or even restrict browsing to only predefined sites. A child lock button 238 can be used to prevent unauthorized changes to settings, for example by children, or can also be customized to make it stop other users from changing settings in a shared environment. In addition, second layer 230 provides trusted website 234 for any site that should have absolute trust. This will allow full access for the site to the local client computer. For example, Sesame Street may have a website, sesamestreet.com, which is implicitly trusted. A user may want to make sure that no blocking takes place for the domain. For blocked websites 236, the list can expand to include having the URL of a website blocked or trusted.

With continuing reference to FIG. 2, the third layer 240 illustrates the Data Traffic Controller system 200 process, which activates software to control and prevent varying types of content. When accessing the Internet, content is made available to a device through various channels. For example, when a customer visits certain websites, it may trigger the download of cookies or other storage locally on the customer computer. Cookies are simple text files that contain two pieces of information: a website name and a unique user ID to identify you. They are downloaded onto your browser directly by the website you are actively visiting and indirectly downloaded by third parties allowed by the visited website. Cookies allow websites to identify you on subsequent visits and across other websites. There are many different kinds of cookies, such as first-party, third-party, session, syncing, respawning, ever, persistent, flash, and tracking cookies. First-party cookies can be used to identify a user so the website can remember and store shopping cart information, log in credentials, and other preferences. The first-party cookies can be either session cookies, which expire on exiting the page, or persistent cookies, which could stay in the browser until you manually delete them. Third-party cookies are cookies belonging to other domains (partners) allowed by the visited website. Third-party cookies have no value and instead are used for personal profile tracking. They allow these partners to identify users across multiple websites, allowing tracking and collection all of personal and private information. This information could include all Internet browsing history and logs, activity at each website, name, address, age, credit card numbers, social security number, medical records, legal and financial documents, and any other information shared online. Sometimes, many cookies are stored locally which a user unknowingly allows.

The third layer 240 prevents and controls using the local computer for such content by outsider parties. Cookies are the most well-known form of online tracking, but there are many other ways browsing behavior can be tracked on websites. In addition, the third layer includes prevention and control of trackers and other third-party content such as flash cookies, also known as “locally shared objects”. These are pieces of information that Adobe Flash might store on your computer. This is designed to save data such as video volume preferences or, perhaps, your scores in an online game. Data Traffic Controller system 200 settings determine how to prevent and control which sites store information on Adobe's website.

The Data Traffic Controller system 200 can also control server logs created when a page loads a website, by making a request to that website's server. A server will log the type of request that was made and will store information such as: IP address (which will allow website owners to infer location), the date and time the browser loaded the page, what page was loaded, and which site or page the browser was on before it came to that page (referrer). These server logs can form the basis for web analytics and can only be seen by the owners of the website.

The Data Traffic Controller system 200 controls web beacons, small objects embedded into a web page but not visible on the page. They can also be referred to as “tags”, “tracking bugs”, “pixel trackers”, or “pixel gifs”. A simple version of this is a tiny clear image that is the size of a pixel. When a web page with this image loads, it will make a call to a server for the image. This “server call” allows companies to know that someone has loaded the page. When a web beacon loads, companies can tell who opened the page, or sometimes a web enabled email, and when.

This system has been abused by spammers who will identify active email accounts by sending emails that include pixel trackers. This is why many email systems will ask if you trust the sender before it displays images. Web beacons are used by advertisers displaying their ads on someone else's website or services that don't have server log access. Often, advertisers will embed web beacons in their adverts to get an idea of how often an advert is appearing. This can be changed from website to website based on the user's preferences and desire for allowing websites to track them in return for access to the website's content.

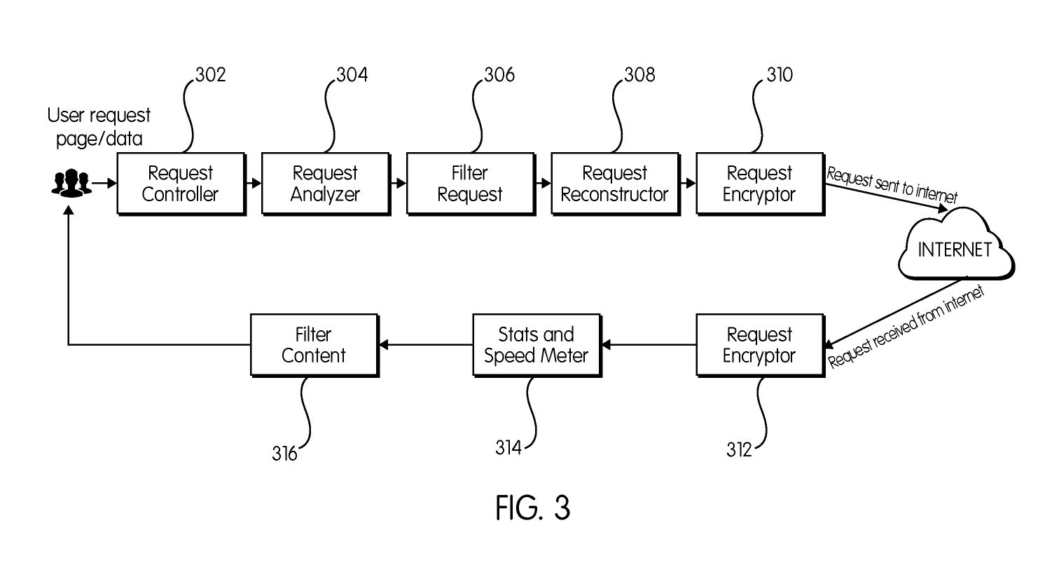

With reference to FIG. 3, the steps of a high level controller function is shown. At step 302 the user enters desired website (URL) in their browser that they would like to visit. This is called a first-party request. At step 304, every request made through a browser gets intercepted by the Data Traffic Controller system and analyzed against a tracker database. Additionally, all third-party content requests are also identified. At step 306, based on the user's settings or desire to block trackers or third-party content, these requests are filtered from the actual request before it is sent out to the Internet service provider. At step 308, when a user chooses either proxy or VPN, then the request is then encrypted and/or routed through a proxy or VPN servers rather than directly to the website. At step 310, the user's browser or app then sends out the filtered and encrypted request for a webpage to the Internet service provider, either directly from their device or through a Wi-Fi connection, Wi-Fi hotspot, or a Mobile Network Operator. At step 312, the filtered webpage request is received from the website and the data is decrypted (proxy/VPN). At step 316, if the user chooses to have website or word filter on, then the webpage content is scanned for any inappropriate words or websites contained in the lists. Based on user preferences, the words are either masked or the entire website is blocked. At step 314, statistics and speed of page load speed is calculated. At step 316, the filtered webpage is then displayed to the user based on their control settings.

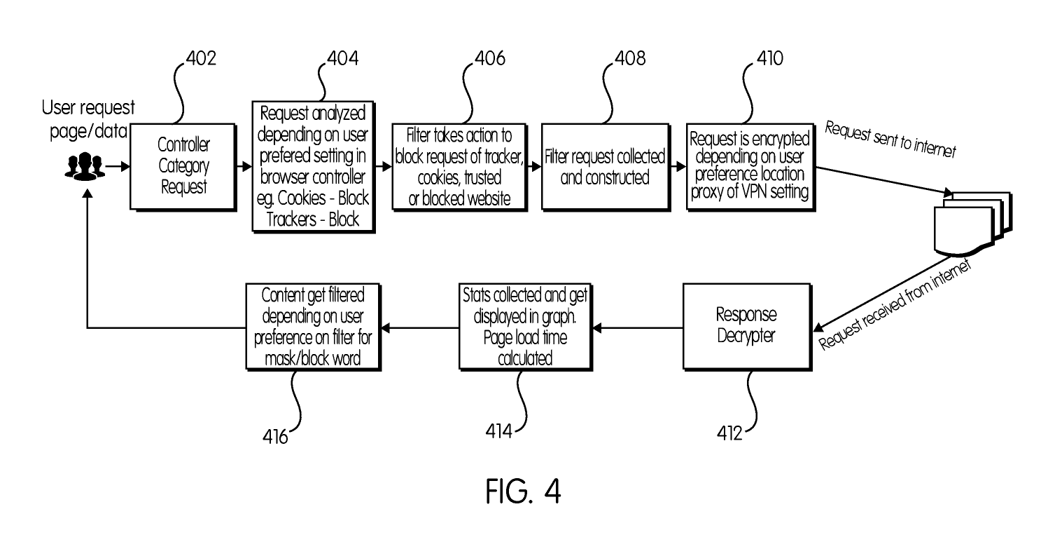

With reference to FIG. 4, the detailed steps of a high level controller function is shown. At step 402, when a user requests data over the Internet through a browser or application, the browser or application sends out a request for a webpage or data to the Internet service provider, either directly from the device or through a Wi-Fi connection, Wi-Fi Hotspot, or a Mobile Network Operator. When the user chooses the proxy or VPN option at step 404, the request is encrypted and sent over the Internet using Wi-Fi and ethernet. At step 406, generally these requests are bundles of requests and categorized in an embodiment, including web objects, such as cookies, images, javascript, xmlhttprequest, or sub frames. Next, at step 408, these categorized requests can be further categorized as trackers, web bugs, web beacons, canvas fingerprinting tracker, image tracker, and pixel trackers. Cookies can be categorized as first-party cookies, third-party cookies, secure cookies, host only cookies, ever cookies, or respawning cookies. One of ordinary skill in the art would recognize this is a non-limiting list, and any malicious or intrusive object downloaded from the web could be blocked. Next, at step 410, the Data Traffic Controller system intercepts page requests and, depending on user filter preferences, websites get allowed or blocked and an appropriate message will be displayed to the user. At step 412, the Data Traffic Controller system intercepts all requests and performs analysis depending on the user's choice to allow or block the request. To understand the severity of the issue, the Data Traffic Controller system calculates the request count and displays to the user. Subsequently, at step 414, filter requests get collected and sent for next processing, once a response is received that data has been decrypted. At step 416, once page is loaded, all intercepted requests have been calculated along with page load time and displayed to the user through a graphical representation and statistics. In addition, the user has been given complete freedom to allow or block any request. At step 416, the user also has ability to check block all requests for current session or complete session. Once the page has started loading, at step 416, depending on user's filter preference, the data gets masked or blocked for inappropriate words. Relative statistics get displayed to the user.

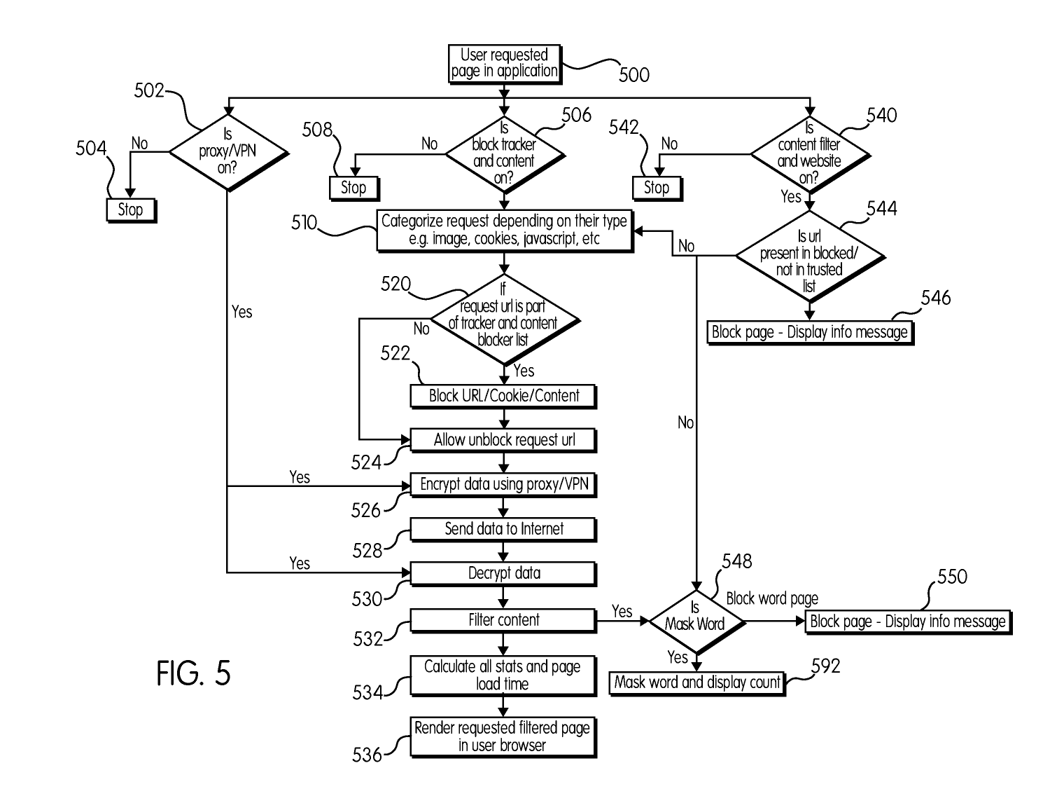

With reference to FIG. 5, when a user requests data over the Internet through a browser or application, at step 500, the browser or application sends out a request for a webpage or data to the Internet service provider, either directly from the device or through a Wi-Fi connection, Wi-Fi hotspot, or a Mobile Network Operator. The Data Traffic Controller system checks user selections for different member algorithms, make me invisible proxy and VPN 502, website and word filter 540, tracker and content blocker 506.

Once the user has requested, if a website and word filter is activated at step 540, a trusted URL only is activated if the requested URL is not in the list at step 544 of untrusted sites, and then the page will get blocked at step 546 and an appropriate message will be displayed. At step 542, if website and word filter is off, the content filtering stops. At step 540, if website and word filter is on and requested URL is in the blocked URL list, the page will get blocked and an appropriate message 550 will be displayed. At step 506, the default setting of the Data Traffic Controller system is set to block all trackers, allow only host cookies; these cookies are generally required by websites to work, allow images, block popup, block sub frame, third-party xmlhttprequest, block third-party other requests, and block social widgets. If it set to not block, the content blocker stops at 508. At step 510, requests are categorized as cookies, images, JavaScript, xmlhttprequest, and sub frames. At step 520, check user preferred setting for current website. If user has “easy fix” allowed for current website, then all content is allowed. If user has custom/default setting, then the respective setting is applied at step 522 and step 524 to block or allow respectively. At step 522, the user has the ability to check block all requests for current session or complete session. At step 526, if the requested URL successfully passes trusted and blocked URL logic and the proxy is on at step 502, then the data sent and received over the network is encrypted and decrypted. If not, proxy encryptor and VPN are stopped at 504.

With continuing reference to FIG. 5, at step 510, these categorized requests can be further categorized as trackers, web bugs, web beacons, canvas fingerprinting tracker, image tracker and pixel tracker. Cookies can be categorized as first-party cookie, third-party cookie, secure cookie, host only cookie, ever cookie, and respawning cookie.

At step 548, the Data Traffic Controller system intercepts page requests and, depending on the user filter preferences, the website is allowed or blocked and an appropriate message will be displayed to user. The Data Traffic Controller system will check the user's preferred settings. If preferred settings is set to easy fix, custom setting, or default setting, the respective setting will get applied. At step 534, the Data Traffic Controller system intercepts all requests and performs analysis depending on the user's choice to allow or block the request. To understand the severity of the issue, the Data Traffic Controller system calculates the request count and displays to the user. At step 532, filter requests get collected and sent for next processing. At step 530, if the proxy encryptor or VPN service is on, a response is received that data has been decrypted.

As shown in FIG. 5 at step 532, once a page has started loading, depending on user's filter preference, the data gets masked or blocked for inappropriate words at step 548. Relative stats of masked word count get displayed to the user at step 592. At step 534, once the page has loaded, all intercepted requests are calculated along with page load time. This is then displayed to the user as a graphical representation and statistics. In addition, the user is given complete freedom to allow or block any request.

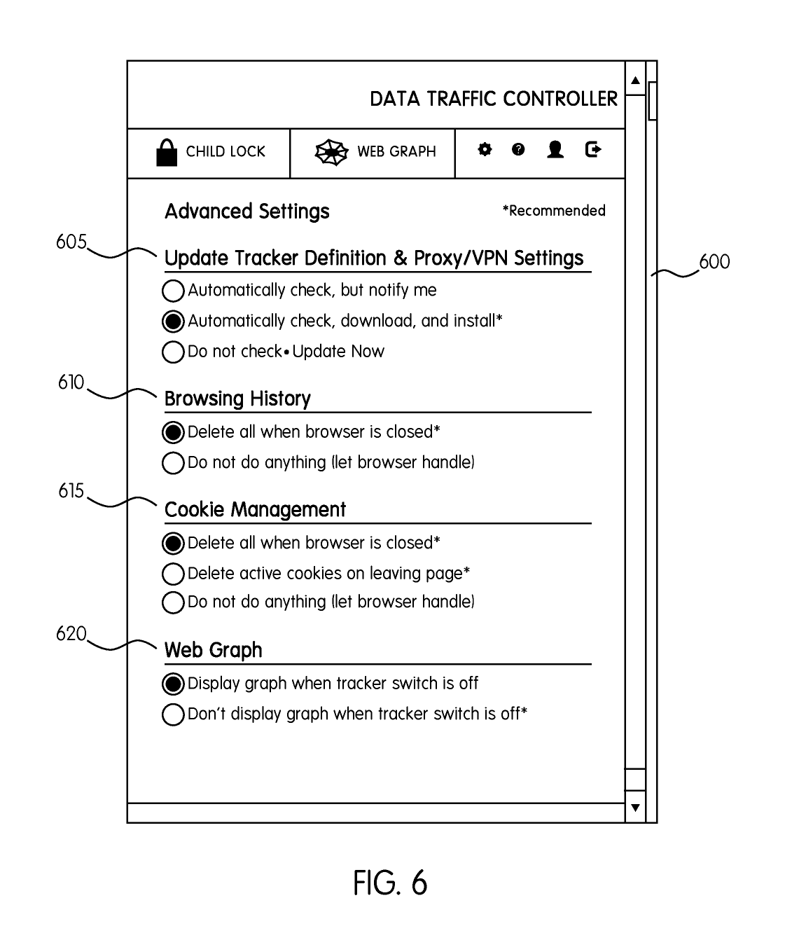

With reference to FIG. 6, a graphical advanced settings interface 600 is used to control some of the features discussed above with reference to FIG. 2. For example, an advanced settings controller 600 can change tracker definition, proxy, and VPN settings and control the efficiency of the Data Traffic Controller system. The settings shown for a preferred embodiment can have other options as well to update how often the databases are updated and how frequently to identify them and block them. Frequency settings can also be changed. The settings determine how to update the Data Traffic Controller system with the latest definitions. A browsing history controller 610 automatically controls how and when to delete a browsing history. Choices provide options whether to delete browse history on close of the browser or having default browser settings to deal with it. A cookie management controller 615 provides a control for management of cookies. Choices provide options whether to delete browse history on close of the browser or have default browser settings to deal with it. A Web Graph 620 can be used to view the cookies and trackers. The view can be used even when the blocker is off or displaying the graph or when the tracker switch is on.

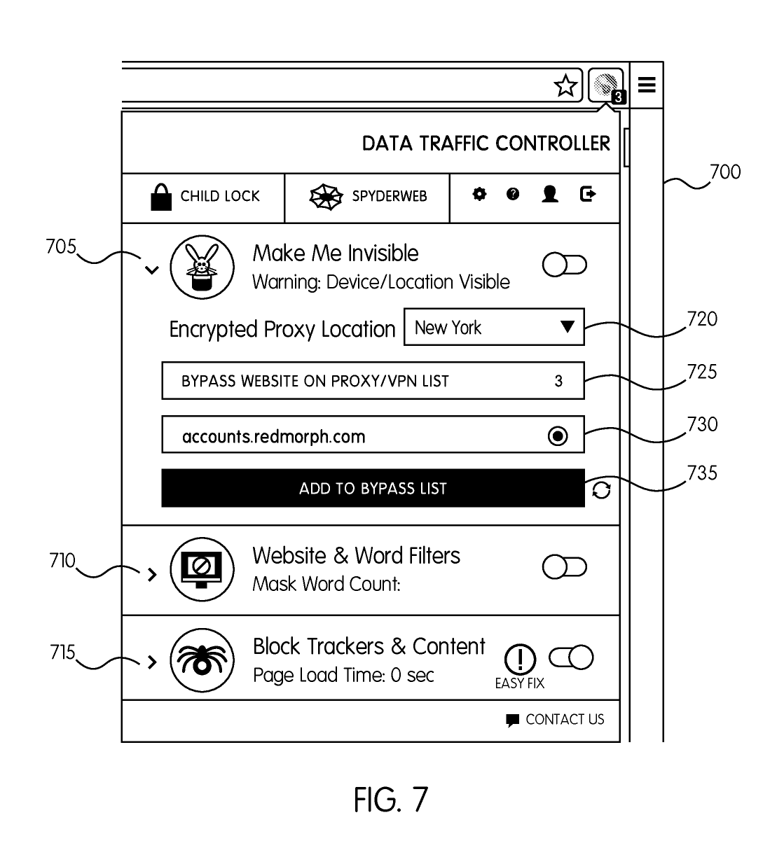

With reference to FIG. 7, a graphical setting interface 700 is used to control features discussed above, with reference to FIG. 2. Make Me Invisible 705 protects the user's identity using online and disguise of location with the encryptor and remote servers. The Data Traffic Controller system encrypts the browser data traffic at Wi-Fi hotspots or from your Internet or Mobile Service Provider. This feature will also hide user location and device information from websites. Encrypted proxy location 720, when activated, is for selecting a desired location, a location closest to the user can be selected from a drop down list for better page load speeds. However, other options can be used for hiding your privacy.

Bypass website list 725 can be used to control encrypted proxy data usage. Turning off invisibility features for sites can be essential for certain websites, as access to content necessarily uses data that is blocked. Websites you would like to bypass are added in box 730 and then activated 735 into the list to bypass the encrypted proxy tunnel and VPN. In an embodiment, the VPN client and the encrypted proxy cannot be used at the same time, however, a person of skill in the art will understand the variations of configuring VPN, a suitable VPN could be made to operate using the encrypted proxy and adding an extra layer of protection. The encryptor provides secrecy beyond the VPN capabilities. In a preferred embodiment, the Data Traffic Controller system will not load webpages if both are on. If a VPN is needed with the additional encryptor, special programming code must be added to account for a user's VPN. Users can turn off encrypted proxy when a VPN clients encrypts and protects both your browser as well as your entire device browser.

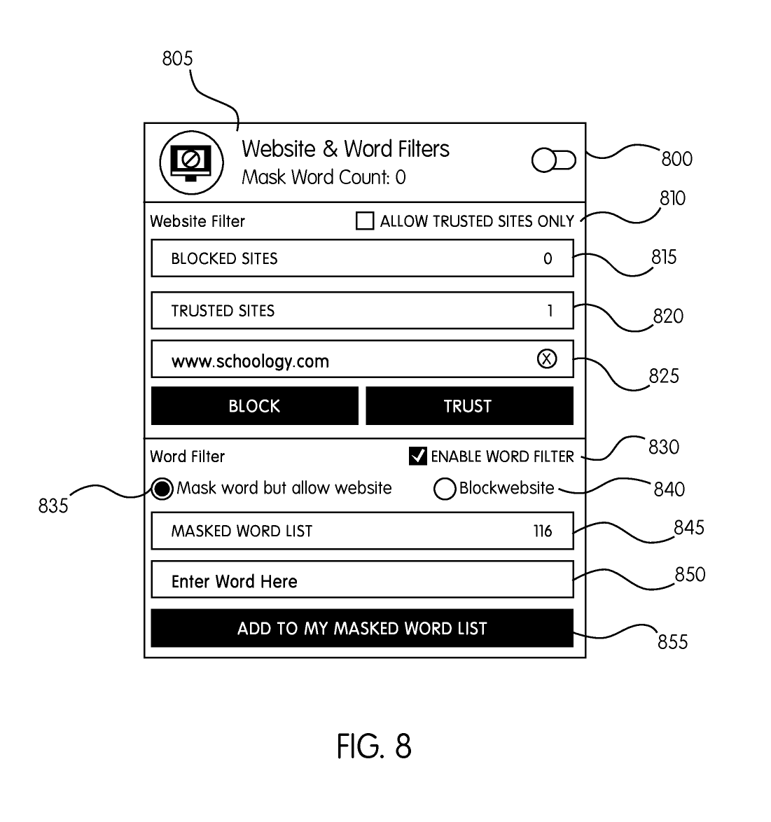

With reference to FIG. 8, a graphical filter interface 800 is used to control some of the features discussed above with reference to FIG. 2. Website and Word Filters 805 can be used for control over words and websites where a user has words that are filtered out or blocked from being accessed. Allow trusted sites only 810 option will permit trusted sites to be viewed in a user's browser. Blocked Sites 815 is a view of which sites are being blocked. Trusted Sites 820 is a view of the list of trusted sites. Block/Trust sites 825 receives an address of a site to either block or trust. Enable Word Filter 830 filters out a masked word list. Mask word but allow website 835 and block website 840 activate a word in a masked word list that appears in a website. The masked word list 845 is a view of a list of masked words. Entry box 850 adds to the list of masked words. Add to my masked word list box 855 can be used to activate an added word above.

Recommended Settings provides potential settings that can be used to protect a browser and are customized in an embodiment for age, but one of skill in the art would understand other settings such as gender, language, or grade, in addition to other classifications, could be used.

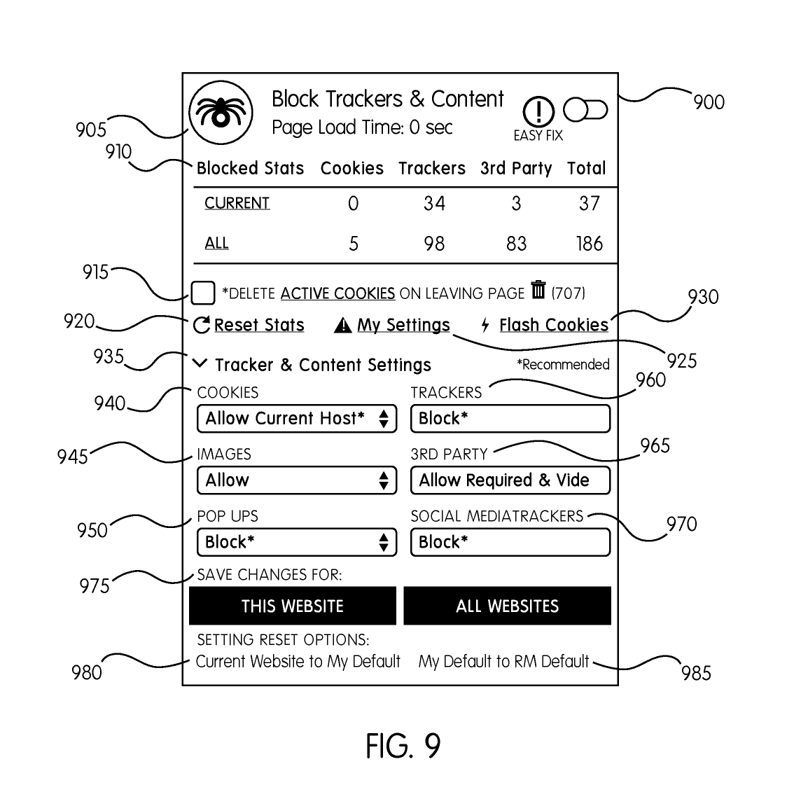

With reference to FIG. 9, a graphical blocker interface 900 is used to control some of the features discussed above with reference to FIG. 2. A block trackers and content easy fix 905 activates the processor to claw back settings to improve content problems. For example, trouble viewing a site is fixed when this feature is used to allow all content, cookies and trackers for a current site. For websites that require login such as social media, emails, shopping, banks, easy fix 905 can override the settings to have all cookies, trackers, and third-party sites operate as intended by the entered website. This can restore and ensure original user experience. Blocked Stats 910 is a view of all objects blocked by the Data Traffic Controller system. Clicking current or all can provide a view each individual item, in a respective context. The delete active cookies box 915 activates the processor of Data Traffic Controller system to delete active cookies on leaving a page. The delete active cookies box 915 can inform the processor to run program code to delete active cookies on a new website, i.e. one that has not been visited until the current session, to delete all first-party active cookies right now. First-party cookies are those delivered with a web page that are not from third parties.

Reset Stats 920 in FIG. 9, wipes stored logistical information, to occasionally reset statistics about content and word blockage. Having new stats gives a user facility to compare results with an active blocker. My Settings 925 shows the universal default settings, custom settings for certain website and the list of websites that have Easy Fix turned on. Data Traffic Controller settings can be edited and personal Data Traffic Controller settings updated here.

With continued reference to FIG. 9, flash Cookies 930 provides additional processing through cookie management interfaces directed to particular flash cookies for managing flash cookies. These are cookies that track Internet movement and store large amounts of information about a user. It is a multimedia and software platform used for creating graphics and animations. However since there is no distinction between good and bad uses, many companies have strayed away from third-party cookies and started using Flash Cookies to save the endless amounts of user information. The main disadvantage of Flash Cookies is that a user cannot locate them in the browser without difficulty. They are not shown in the list of cookies and do not appear in databases or other browser-specific storage locations. Protection is provided from Flash Cookies by disabling them using the Data Traffic Controller.

Tracker and Content Settings 935 activates options for cookie management for a particular site. The settings are granular for each type of content. The cookies drop down 940 is for controlling cookies for a particular site. In a preferred embodiment, not limiting, three options are available: allow current host: allows only cookies for the current site (active required cookies); allow all: allow all cookies even the ones that are not required such as from trackers, advertisers and third parties; and block all: blocking all cookies may affect how the page performs. These options can be applied to the other types of blocked content. Images 945 the feature can block pages with many images that can effect page load times and bog down a website. If you have a poor Internet connection or do not have an unlimited data plan, this option provides the Data Traffic Controller system control to block images. Pop ups 950 can prevent websites, cookies, and advertisers can trigger pop-ups almost any time. Trackers 960 blocks objects besides cookies, other ways for companies tracking information about user's activing and movements online. Many of the new tracking technologies do not require a cookie and are woven into the fabric of the webpage and are hard to detect.

Third-party box 965 is an option to block parties that include data networks collecting browsing data, advertisers, or could provide content such as videos, embedded slideshows, used to monitor user activity. In a preferred embodiment, the following options activate the processor according to level of prevention: allow all to allow all third-party content, including the ones that may not be in your best interest; allow required to only permit necessary third-party content that is required to load the page; allow required and video to permit necessary third-party content and videos only from third parties, such as YouTube and Vimeo-type sites to host their videos. Blocking stops the cases where video hosting companies will download their cookies and trackers before the video is loaded; and block all for blocking everything and anything that could affect how the page loads.

Social media trackers box 970 stops trackers used by social media to track your online habits outside of the social network and make advertisements to target users with their social network. Saving preference changes box 975 activates programming code for the option to save custom preferences for the current site or to apply current settings for all websites. Resetting settings 980 can apply default settings to the current site by clicking on current website to default or opt to reset your default settings to Data Traffic Controller system defaults by choosing default to RM default 985. Users can view the current default settings in “my settings.”

Although the invention has been described with reference to a particular embodiment, this description is not meant to be construed in a limiting sense. Various modifications of the disclosed embodiments as well as alternative embodiments of the invention will become apparent to persons skilled in the art. It is therefore contemplated that the appended claims will cover any such modifications or embodiments that fall within the scope of the invention.

1. A computer-implemented method for protecting users browsing the Internet, comprising:
displaying a plurality of selectable options in at least one graphical user interface;
intercepting, on a user computer from a web browser executing on the user computer, a plurality of requests for content associated with a host webpage;
in response to user selection of a first selectable option of the plurality of selectable options, connecting to at least one of a virtual private network (VPN) and a proxy server;
in response to user selection of a second selectable option of the plurality of selectable options, analyzing each of the plurality of requests for content based on at least one database stored locally on the user computer to identify requests associated with content to be blocked;
transmitting, to an Internet service provider, a second plurality of requests for content associated with the host webpage, wherein the second plurality of requests for content comprise the plurality of requests for content without the requests for content associated with the content to be blocked;
receiving web content from the Internet service provider corresponding to the second plurality of requests for content; and
in response to user selection of a third selectable option of the plurality of selectable options, filtering the web content based on at least one keyword.

2. The computer-implemented method of claim 1, wherein the at least one graphical user interface is displayed within a web browser.

3. The computer-implemented method of claim 1, wherein at least the steps of intercepting, transmitting, and receiving are performed by a web browser extension or plug-in.

4. The computer-implemented method of claim 1, further comprising: after receiving the web content, generating a graphical user interface comprising a visual diagram illustrating the plurality of requests for content associated with the host webpage and the requests for content associated with the content to be blocked.

5. The computer-implemented method of claim 1, further comprising:
determining a page load speed for the host webpage; and
displaying the page load speed.

6. The computer-implemented method of claim 1, wherein the content to be blocked comprises at least one of the following: a tracker, a cookie, third-party content, a pop-up window, a web bug, or any combination thereof.

7. The computer-implemented method of claim 1, further comprising:
encrypting, by the virtual private network or proxy, outgoing data from the user computer; and
decrypting, by the virtual private network or proxy, incoming data from the host website.

8. A computer program product for protecting users browsing the Internet, comprising a non-transitory computer-readable medium including program instructions for providing a web browser extension or plug-in that, when executed by a user computer, causes the user computer to:
(a) display a plurality of selectable options;
(b) receive, from a web browser running on the user computer, an indication of a URL for a host webpage to be visited;
(c) in response to determining that a first selectable option of the plurality of selectable options has been selected:
(i) intercept a plurality of requests for content associated with the host webpage from the web browser;
(ii) determine a subset of requests for content to be blocked from the plurality of requests for content based at least partially on at least one database;
(iii) transmit, to an Internet service provider, a second plurality of requests for content comprising the plurality of requests for content minus the subset of requests for content to be blocked; and
(iv) receive web content from the Internet service provider based on the second plurality of requests for content;
(d) in response to determining that a second selectable option of the plurality of selectable options has been selected: filtering the web content based at least partially on at least one keyword; and
(e) displaying the web content in the web browser.

9. The computer program product of claim 8, further comprising: in response to determining that a third selectable option of the plurality of selectable options has been selected, connecting to at least one of a virtual private network and a proxy server, wherein the second plurality of requests for content are encrypted before being transmitted to the host webpage, and wherein the web content is decrypted before being received by the user computer.

10. A system for protecting users browsing the Internet, comprising:
(a) a web browser extension or plug-in native application, executing on a user device, programmed or configured to:
(i) display a plurality of selectable options;
(ii) receive, from a web browser executing on the user device, an indication of a URL for a host webpage to be visited;
(iii) in response to determining that a first selectable option of the plurality of selectable options has been selected:
(1) intercept a plurality of requests from the web browser for content associated with the host webpage;
(2) determine a subset of requests for content to be blocked from the plurality of requests for content based at least partially on at least one database;
(3) transmit, to an Internet service provider, a second plurality of requests for content comprising the plurality of requests for content minus the subset of requests for content to be blocked; and
(4) receive web content from the Internet service provider based on the second plurality of requests for content;
(iv) in response to determining that a second selectable option of the plurality of selectable options has been selected: filtering the web content based at least partially on at least one keyword; and
(v) displaying the web content in the web browser; and
(b) a server computer configured to provide a proxy or virtual private network, the server computer configured to encrypt outgoing data from the user device and decrypt the web content before being received by the user device.

11. A browser control system configured for securely browsing the Internet, comprising:
a browser running on a processor, coupled with a first and second memory;
a first memory configured to store at least one address of a website that is tracking user activity;
a second memory for storing user preferences;
a first selectable option to initiate and create a secure channel for a user's entry to the Internet using a concealed server service;
a second selectable option for turning on a blocker, wherein said blocker is configured to read the contents of the first memory and to provide control for the browser to withhold requests to download of cookies, trackers and third-party content from a website associated with said address;
a monitor of incoming and outgoing traffic, wherein a request made through a browser gets intercepted by the monitor and analyzed against a tracker database to identify all third-party content requests are also identified.

12. The browser control system of claim 11, wherein said secure channel blocks access to any outside party for gathering of information.

13. The browser control system of claim 11, further configured to display a visual representation of the trackers and third-parties they have exposure to on every website and across different websites, graphic display.

14. The browser control system of claim 11, further configured with three layers of protection that the user can choose to turn on or off.

15. The browser control system of claim 11, further configured with encryption services to prevent Internet service providers from tracking a user's Internet activity or browser.

16. The browser control system of claim 11, further configured to provide flexible control for changing from one website to a second website based on a user's preferences and desire for allowing websites to track them in return for access to the website's content.

17. The browser control system of claim 11, further configured ability to filter or block websites based on specific URLs or words.

18. The browser control system of claim 13, where the visual representation is a connectivity graph showing protected and unprotected sites that a user has connected with by either visiting or through another party.

19. The browser control system of claim 18, further comprising,
a third selectable option in the visual representation, the third selectable option representing a third party and for turning on blocking for the third party.

20. The browser control system of claim 18, wherein the third selectable option can initiate a report to an authority to block, monitor, contact, or limit contact of a party or tracker associated with the third selectable option.
